(19) United States
(12) Patent Application Publication
(10) Pub. No.: US 2025/0308397 A1
(43) Pub. Date: Oct. 2, 2025

(54) STUDENT ENGAGEMENT TRACKING AND ANALYSIS SYSTEM

(71) Applicant: Lenovo (Singapore) Pte. Ltd., Singapore (SG)

(72) Inventors: Joshua Smith, Milton, FL (US); Matthew Fardig, Boonville, IN (US); Tyler Nicholls, Lehi, UT (US)

(21) Appl. No.: 18/617,311

(22) Filed: Mar. 26, 2024

(51) Int. Cl. G09B 5/02; G06F 18/20

(52) U.S. Cl. CPC G09B 5/02; G06F 18/20

(57) ABSTRACT

A computer implemented method includes monitoring, by one or more processors, student interactions with computing devices during a class session to collect student interaction data and obtaining an engagement score representative of a student being on track by interacting with content relevant to a predefined learning objective. A communication is selected to direct the student to interactions to increase the engagement score. Following the communication, student interactions are monitored to determine a post communication engagement score. An effectiveness score of the communication is modified based on a change between the post communication engagement score and the engagement score.

### BACKGROUND

The integration of digital tools into the classroom has transformed the learning environment. With the advent of individual computing devices for students, the educational landscape has seen a significant shift towards personalized and technology-enhanced learning experiences. However, this digital integration also presents challenges, particularly in maintaining student engagement and ensuring that students remain focused on educational tasks during class time.

K-12 Classroom teachers wear a lot of hats. Among all their responsibilities is trying to keep students on task and engaged in proactive learning. When a student is frequently disengaged, it is much more likely that they will not be able to achieve the educational goals of the classroom. Additionally, teachers now operate in classrooms where every student is likely to have their own dedicated computer. This introduces exciting new opportunities for classrooms but it also presents new challenges. Students can easily get distracted by different websites when they should be working and on task.

Today teachers try to balance this task in addition to everything else they need to do, or the school hires additional support from teaching assistants or paras. With the education shortage throughout the country, and the expensive price tag that hiring support can be, it is difficult to secure this sort of support in the classroom.

Some of these concerns may be addressed by enabling web and app limiting and by giving teachers access to a blank screen feature. This helps to a degree but does not solve the problem fully.

The current state of technology in education includes various software and hardware solutions aimed at facilitating classroom management and student monitoring. These solutions range from basic screen monitoring to more advanced systems that limit access to non-educational content. Despite these advancements, there remains a need for more sophisticated methods to accurately assess and enhance student engagement in real-time, without placing additional burdens on educators who already manage diverse and complex classroom dynamics.

Existing systems often rely on manual oversight by teachers or simplistic algorithms that do not account for the nuanced behaviors indicative of student engagement or disengagement. As such, there is a gap in the market for a system that can intelligently and autonomously determine student engagement levels and provide actionable insights to educators, thereby supporting the primary goal of education: to foster an environment conducive to learning and intellectual development.

### SUMMARY

A computer implemented method includes monitoring, by one or more processors, student interactions with computing devices during a class session to collect student interaction data and obtaining an engagement score representative of a student being on track by interacting with content relevant to a predefined learning objective. A communication is selected to direct the student to interactions to increase the engagement score. Following the communication, student interactions are monitored to determine a post communication engagement score. An effectiveness score of the communication is modified based on a change between the post communication engagement score and the engagement score.

### BRIEF DESCRIPTION OF THE DRAWINGS

FIG. 1 is a block diagram of an education platform for tracking student performance and providing real time feedback according to an example embodiment.

FIG. 2 is a representation of an example instructor interface according to an example embodiment.

FIG. 3 is a flowchart illustrating a method of generating real-time feedback for an educator according to an example embodiment.

FIG. 4 is a flowchart illustrating a method of generating nudges for students who are found to be not on-track to interacting in a manner consistent with a learning objective according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

An improved education system is used to track progress of students toward a selected learning objective. The system monitors the interaction of each student working on a student system, such as a laptop or tablet. Content being viewed by the students is analyzed via a machine learning model that has been trained on topics and content labeled based on relevance to the topics. In one example, progress of students may take the form of on/off-track ratings provided to an instructor. In some examples, the rating may be used to generate nudges for selected students based on their corresponding rating to nudge them back on-track.

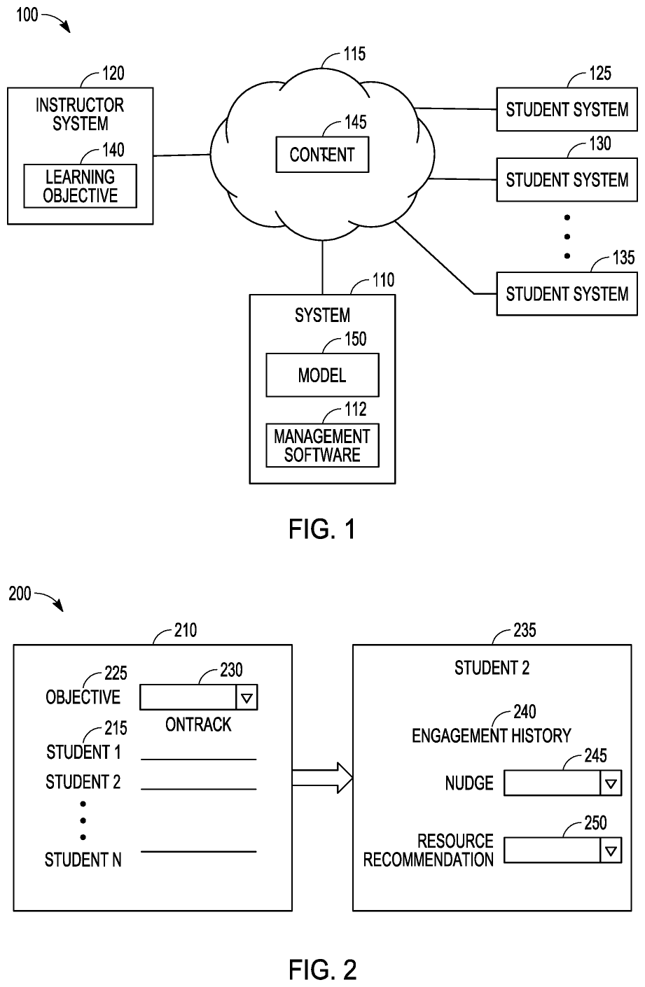

FIG. 1 is a block diagram of an education platform 100 that includes an education system 110 coupled via a network 115 to an instructor system 120 and multiple student systems 125, 130, 135. Education system 110 may execute classroom management software 112.

In one example, an instructor using instructor system 120 may provide a learning objective 140 as input, such as: “Discuss the most historically impactful events of Abraham Lincoln's Presidency.”

As students interact with the corresponding student systems 125, 130, 135, to access content 145 via network 115 or even locally stored content on each of the student systems 125, 130, 135, The interactions are tracked via system 110 in one example, identifying each interaction or a log of interactions with a corresponding student. System 110 may be configured to mirror content accessed by the student systems 125, 130, 135 or even track URLs accessed, and independently access the same URLS to obtain the content for analysis. A time that each piece of content is viewed may also be tracked by system 110.

System 110 may then use a trained model 150 to compare accessed content to the learning object 140 and generate a relevancy score. The model 150 may be implemented in system 110, instructor system 120, or in cloud based resources accessed via the network 115.

In various examples, the model may be trained based on different types of topics selected from multiple different curricula, and content containing text related to such topics that are labeled based on relevance to the topics. The relevancy of each piece of content may be calculated using a language model, such as model 150, based on how well the topics in the content match the learning object. The relevancy is used to help generate a score for whether or not a student is on-track. The content may include text and images in various examples. Different models trained on text content, image content, or a model trained on both text and image content may be used. Optical character recognition may be used for images containing text to derive text from the images.

The learning objective 140 may be provided by the instructor or may be derived from student interactions using comparative analytics. In one example, the learning objective may be derived by determining via the language model that 80% of the class is looking at content corresponding to topics such as “The Gettysburg Address” and “Lincoln's Assassination” which may be referred to as matching content. Other students are interacting with content corresponding to topics such as “IGN Video Game Reviews” or “Latest TikTok Challenges” which do not match what 80% of the class is looking at. Based on that numerical evidence, it can be determined that the learning objective appears to be “Things Related to Abraham Lincoln” which corresponds with the above instructor determined learning objective 140 of “Discuss the most historically impactful events of Abraham Lincoln's Presidency.”

A threshold at which content corresponding to topics is considered matching may be set by the instructor based on the type of class that is being held or determined from prior thresholds used for similar examples. In a research-based class when Student A is looking at content related to Topic A, Topic B and Topic C, while Student B is looking at content related to Topic A, Topic B and Topic X, a 66% match of topics would be considered “being on the same topic” overall. In a research-based classroom, any threshold over 50% would provide great value when determining a match or not. However, in a classroom that is very strict that requires students to be entirely focused on 2 topics, the threshold would be tighter. For example a 75% or higher threshold might be desired. For example, in a classroom of this type, Topic A and Topic B might be the desired topics. If Student A is on Topic A, Topic B, and Topic C, it might be found that Student A is only 66% on topic. Based on the higher threshold and the desire that students are fully engaged, this would be considered off topic in a classroom of this type.

The model 150 provides relevancy scores for content being viewed by a student. The relevancy scores are used by system 150 to determine if student is “on-track” if the relevancy scores are indicative of the content matching the established learning objective 140 or “off-track” if the relevancy scores are indicative of the student viewing content not related to the established learning objective. A confidence rating for each piece of content's relevance to the learning objective may be used as the content relevancy score. The relevancy scores for a student may be averaged in one example to provide an overall on-track score.

An on-track threshold, also referred to as an engagement threshold, may then be used to determine whether or not the student is on-track. In one example, the relevancy scores are percentages. The engagement threshold may be greater than 50% in one example where the learning object is well defined, such as in the Lincoln example: “Discuss the most historically impactful events of Abraham Lincoln's Presidency.” This example is very topic specific, and the engagement threshold may be set closer to 80%. The engagement threshold may be set by the instructor, or may be suggested by the system calculating the engagement threshold based on relevancy scores for other students in the class. In one example, the suggested engagement threshold is a value corresponding to the lowest relevancy score of where the top 50%-80% of the class. The instructor may be provided a graph or bar chart showing the relevancy scores of students from which a desired engagement threshold may be set by the instructor. Such a chart also helps the instructor find the lowest performing students that need help in staying on-track.

In various examples, URLs that students visit result in a topic analysis on those content corresponding to the URLs. Several different large language models may be used to provide a topic analysis. For URLs that contain text, optical character recognition (OCR) to convert all of the words currently displayed on the student system screen (in this case in the web browser) into text. This text can be fed into topic analysis algorithms as well as summary analysis algorithms (all of which are known art).

In another text-based example, a backend process (such as a process running in the cloud) may be used to access the same URLs on its own, and retrieve ALL of the content from the pages associated with the URL and not just the content actively shown on the student system screen. The text can be scraped from the website (for example by pulling all text out of the HTML code returned from the accessed URL) and then fed into the same topic analysis or summary analysis algorithms.

For non-text based content, computer vision may be used to determine what is on a student screen. Computer vision is known art. Processing of non-text based content may include analyzing thumbnails to determine what topics the text/images represent on the student's screen. For example, a student has a local application opened that is showing pictures of Abraham Lincoln, or includes text from the Gettysburg Address, etc.

In one example classroom management system, such as LanSchool Air by Lenovo, images, such as thumbnails, of the content of each student screen are sent to the cloud on a given interval (for example, every 5 seconds). Screen shots may be used to capture the content viewed on the screen that is sent to the cloud. The system also allows the instructor to view the content.

System 110 may receive such thumbnails or screenshots and provide the thumbnails to various computer vision algorithms to analyze both the text and the graphical content (such as images) contained in those thumbnails.

This sort of analysis works with anything on the student screen, not just web sites. For example, if the student is using Education Software A, and they are currently typing information into that software, that information being typed could be used in the on-track analysis.

Noting how long a student spends on a given resource and frequency of visit to that resource may also be used to help develop the relevancy score for the resource with corresponding content. In one example, Student A is on website A and stays there for 10 minutes (might indicate usefulness) vs Student B is on website B and leaves after only 30 seconds (might indicate site wasn't useful). The length of time may be determined by comparing captured content over time to determine if the same content (or website as indicated by the URL) is still being viewed. Since the frequency of capture is known, the time on the website can be calculated.

Usefulness of a website may also be based on the amount of text found on the site in combination with the amount of time on the site. The average rate of silent reading for a human is around 238 words per minute. On a site containing over 600 words, spending 2½ to 3 minutes could be considered a length of time that indicates usefulness. However on a site with that many words, spending 30 seconds or less could indicate the student quickly found the site to not be useful.

In another example, x % of the class has found their way to a given resource. Using comparative analytics it can be determined that the resource is useful if a large percentage of the students have used it. The range of an effective x % here would depend on the number of students in a classroom. In a classroom of 20 students or more, any value of x over 75% would indicate a very confident decision by the software. Any value around 50% might indicate a high possibility the resource is useful, while anything less might indicate the resource was easy to locate, but possibly doesn't have value to the task at hand.

The higher the number of students, the more confident a given percentage might be. For example 75% of a classroom with 100 students is far easier to trust than a 75% score for a classroom with 4 students. The larger sample size helps build confidence in the software's decision.

In one example, x % of a class has found their way to a resource with a similar topic. If a large percentage of the students end up at resources with similar topics, it can be determined that these students are finding these resources useful and are on-track.

In one example, an instructor may record a manual “on-track” or “off-track” assessment using system 110. An instructor may be reviewing Student A's thumbnail of their screen and clicks a button in the classroom management software 112 to say “Great job Student A”. The resources being viewed/used by Student A can be determined to be useful to be on-track for the assignment. Likewise, an instructor could review the suggestion from the software that a student is on/off-track and then override the suggestion from the software.

In a further example, the topic of the day might be solving problems using long multiplication (the traditional way of solving this type of problem). However, one student is on a page looking at the grid method. While not as popular, this method is also used to solve multiplication problems. The software might feel that this is off task because the student is looking at something different. However, the instructor is aware that the grid method has value, even though it isn't what is being taught, so they override the software suggestion. This becomes useful to help instruct the machine learning algorithm as to what can also be considered on-track by adding topics that should be considered on-track.

In various embodiments, the methods of determining relevance scores may combine one or more of the above methods, weighting the results of each method as desired. For example, the model may perform the topic analysis to generate a confidence score. The confidence score may be varied depending on one or more of the amount of time spent viewing the content, on the number of other students viewing the content, and on the manual assessment. In one example, the model is trained to consider each of the one or more methods.

The system 110 may provide several different forms of output. In one example, the system 110 uses the on/off-track ratings for each student to notify the instructor in at least one of several ways, such as use of a graphical element, audio cues, or even by generating a communication to the student, referred to as a nudge, to help guide or nudge a student back on-track.

The machine learning model 150 is a specialized component designed to analyze student engagement by evaluating the relevance of student interactions with respect to the learning objectives 140. Model 150 may be trained on a dataset that includes examples of both engaged and disengaged student behaviors, as well as the content they interact with, to learn patterns that are indicative of each state based on topics derived from both the learning objective and observing student interactions from all the students in a class.

In various examples, machine learning model 150 may perform natural language processing (NLP). Algorithms such as Term Frequency-Inverse Document Frequency (TF-IDF), Latent Semantic Analysis (LSA), or more advanced deep learning models like BERT (Bidirectional Encoder Representations from Transformers) may be used to analyze the text content accessed by students. These algorithms can help determine the relevance of the content to the learning objective 140 by understanding the context and semantics of the text.

Topic modeling may be performed by algorithms like Latent Dirichlet Allocation (LDA) or Non-negative Matrix Factorization (NMF) to identify the underlying topics within the content that students are accessing. By comparing these topics to the learning objectives, the system 110 can assess whether students are focusing on relevant material.

For content that includes images, computer vision techniques using Convolutional Neural Networks (CNNs) can be applied to identify and classify images that are relevant to the learning objectives. This can be particularly useful for subjects where visual content is important, such as art history or biology.

Sequence analysis algorithms, such as Hidden Markov Models (HMMs) or Recurrent Neural Networks (RNNs), may be used to analyze patterns in student behavior over time, such as the sequence of websites visited or the duration spent on particular resources.

In further examples, algorithms like One-Class SVM or Isolation Forest could be used to detect outliers in student behavior, which may indicate disengagement or off-task activities. K-means clustering or hierarchical clustering could be used to group students based on similarity in their engagement patterns, which can help in identifying common resources or activities that are effective in maintaining engagement. Reinforcement learning algorithms could be used to optimize the on task versus off task analysis performed by system 110. By receiving feedback on the effectiveness of previous nudges or recommendations, system 110 can learn and improve the suggestions made to help students get back on-track.

In some examples, Decision Trees and Random Forest algorithms can be used to classify student engagement based on a variety of input features, such as time spent on tasks, frequency of resource access, and match with the learning objective.

Machine learning model 150 may be integrated into system 110 such that the model continuously learns and adapts based on new data, thereby improving its accuracy and effectiveness over time. The model would also be designed to respect student privacy and comply with relevant educational data protection regulations.

Machine learning model 150 as described above may be trained using a variety of data that captures student interactions with educational content and their behavioral patterns during class sessions. The goal of the training process is to enable the model to distinguish between behaviors that indicate engagement with the learning objectives and those that suggest disengagement.

Some examples of the types of data that may be used for training the model and how the training process might be conducted include student interaction data, such as logs of URLs visited, duration of visits, frequency of access to certain resources, and patterns of resource usage during times related to work on the learning objectives, such as during class sessions.

Further data includes content analysis data. Textual and visual content from educational resources that students interact with would be analyzed. Text data would include keywords, topics, and summaries, while visual data might include images or diagrams relevant to the learning objectives.

Engagement annotations may include data labeled by educators indicating whether a student was on-track or off-track based on their observed behavior and the relevance of accessed content to the learning objectives. Feedback data may include information on the effectiveness of previous interventions or nudges provided by the system, including any manual overrides or confirmations of engagement status by educators,

Student performance metrics may include grades, quiz scores, and other performance indicators that can be correlated with engagement levels to provide ground truth data for the model.

The training data may be used in one of several different training processes, including supervised learning where training is performed using labeled datasets where relevance to being on or off-track is known and included in the training data. The model 150 learns to associate patterns of interaction and content relevance with the correct status of being on or off-track.

Unsupervised learning techniques like clustering may be used to identify natural groupings of student behavior without pre-labeled data. These clusters could then be analyzed to infer engagement levels based on similarities to known engaged or disengaged behaviors.

Semi-Supervised Learning may use a combination of labeled and unlabeled data to improve the model's accuracy, especially when there is a limited amount of labeled data available.

Using reinforcement learning, the model could be trained using a reward system where positive outcomes from interventions (such as a student returning to on-task behavior) reinforce the model's decision-making process.

Important features may be extracted from the raw data, such as the semantic similarity between accessed content and learning objectives, time-series analysis of student activity, and frequency of off-topic resource access.

Privacy preserving techniques may be utilized to ensure the model is trained in compliance with privacy regulations, ensuring that student data is anonymized or pseudonymized as necessary and that data handling follows ethical guidelines.

The training process may involve iterative refinement, where the model's predictions are continuously compared against actual outcomes to improve its predictive capabilities. The model would also be regularly updated with new data to adapt to changes in educational content, learning objectives, and student behavior patterns.

Educators could use a variety of user interfaces to view and respond to the real-time engagement feedback provided by the system. These interfaces may be designed to be intuitive and user-friendly, allowing educators to quickly understand the engagement levels of their students and take appropriate actions. Some examples of user interfaces that could be utilized include a dashboard interface with an overview panel that displays a summary of the class's overall engagement level, with color-coded indicators or graphs showing the distribution of engaged versus disengaged students.

FIG. 2 is a representation of an example instructor interface 200. A first view 210 includes a list of each of the students 215 with an associated on-track indicator 220. First view 210 includes an objective field 225 with a drop-down box 230 for selecting an existing objective or generating a new objective. Once the objective is selected, the on-track indicator 220 is updated for each student.

Each student entry on the list of students 215 is selectable to provide a second view 235 that includes an engagement history 240 for each student, and a nudge 245 drop-down menu or list of selectable nudges to provide the student at the option of the instructor. The selected nudge may be sent by email, text, or otherwise. A resource recommendation list 250 or drop-down menu is also provided.

The detailed list or grid view of all students 215, with individual engagement status or on-track indicators 220, such as icons or progress bars, next to each student's name. Pop-up alerts or a dedicated notifications area may be provided where the system highlights students who may need immediate attention due to disengagement.

The detailed view 235 for each student includes their engagement history 240 which may include accessed resources, and any notes or interventions from the educator. A chronological timeline showing the student's activity during the class session may also be shown, with markers indicating engagement status changes or interactions with nudges.

In one example, the detailed view 235 for the student may include nudge buttons 245 and resource recommendations 250. The nudge buttons may include quick-access buttons that allow the educator to send predefined or customized messages to students, encouraging them to refocus or access particular resources. Resource recommendations may point to educational resources that the educator can recommend to students to help them get back on-track. Both the nudge buttons and resource recommendations may be provided in drop-down lists or other user interface constructs allowing easy selection.

System 110 may also provide analytics and reporting such as engagement reports that summarize engagement data over time, allowing educators to identify patterns and assess the effectiveness of their teaching strategies. Classroom analytics may include visual analytics, such as heatmaps or scatter plots, that provide insights into classroom dynamics and student engagement levels.

The nudge buttons 245 and resource recommendations 250 in the educator user interfaces may be used to guide a student in a connected classroom (in person or remote) back on-track once the system 110 has determined they are off-track.

Once a student has been determined to be off-track or approaching off-track, the system 110 may utilize logic to perform one of many different options for nudging the student back on-track. In one example, the established learning objective may be surfaced to the student as a reminder. For example, Student A might receive a notification saying “As a reminder, today we are focusing on the presidency of Abraham Lincoln”. This reminder may be sent automatically or may be provided as an option for the instructor to select or approve for sending via the instructor user interface.

In a further example, system 100 may automatically, or in response to a selected educator prompt, show the student a list of resources that were pre-determined by the instructor to be useful. The list of resources may be provided to the student with a suggestion that the student utilize resources on the list.

The list of resources may be provided prior to intervention by the instructor to provide this list. In a situation where some useful resources are provided in this manner, the instructor would need to input these into the system prior to the class session. This could be accomplished through importing a list of resources from an agenda tracking software of an education system incorporating system 110 or inputting them manually. In this situation, the resources are known to the instructor ahead of time and provided in a way that the software can access this list to provide to the students as needed.

An instructor may provide a score that could be used to determine how much nudging is provided by a given resources. For example, if the implementor decided to utilize a scoring range of 1 thru 10, a one might indicate that a given site has a little bit of information about the topic but will help guide the student toward better resources. A 5 might indicate that some answers are provided on the given site, however the site will also help guide the student to find their own answers on other sites. A 10 might indicate that every answer necessary for the assignment can be found on that resource.

In a further example, the system 110 may be programmed to learn what this score should be based on providing it to students and then determining if they are determined to be more on-track in a few minutes or less on-track. This would facilitate learning values or thresholds for these sites rather than relying on manual intervention ahead of time by the instructor.

In still a further example, the instructor may select, or the system may automatically show the student a list of resources that were determined to be useful to others based on comparative analysis. For example, once 10 students are determined to be on task, a list of some of the more useful resources they have used is presented to the off-track student.

This method of determining useful resources as opposed to just providing resources predetermined by the instructor, this implementation allows the system 110 to determine the usefulness of websites that students discover on their own. The method of providing the useful resources is similar to the methods described above with the exception being that the students discover the websites during their own research.

The “nudge” toward being back on-track adapts based on the context or type of classroom. In a research-based classroom, the nudge may be more subtle, and more suggestion based. In a strict classroom with a project deadline, the nudge is far less subtle and could automatically take a student to the suggested resources. In a classroom that is research focused, it may be desired to promote the idea of looking around for answers and not being just told where to go or what to look at. The idea is that the student learns as they go and hopefully finds their way to understanding the topic being researched. Along the way they will find useful resources and not so useful resources. However, there may be no need to allow a student to be off-track for too long. In a 1 hour class, after 15 minutes of remaining off task for example, the software might provide a nudge with a resource that has been shown to bring students partially back on-track. This gentle nudge gets them closer to where they need to be but doesn't force them over to the exact answers being sought. However, if the same situation occurs 45 minutes into a 1 hour classroom, a resource that has proven effective in getting other students back on-track quickly might be provided.

Once a nudge has been provided, if the student starts to get back on-track, the resources used by the student to get there can be targeted for use as nudge suggestions for others in similar off-track situations. In other words, the effectiveness of the nudge is measured based on where the student was compared to how the student progressed toward being on-track following the nudge. The measure of effectiveness can be used to determine if that particular nudge might be effective for other students.

If the student continues to stay off-track, note that the particular nudge was not effective. This information can be used to determine if that nudge is used again or not. A different type of nudge may be provided to the student in question.

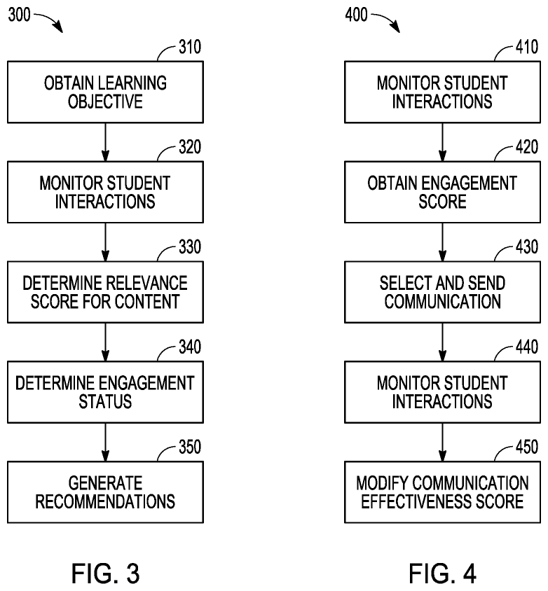

FIG. 3 is a flowchart illustrating a method 300 of generating, by one or more processors, real-time feedback for an educator. Method 300 begins at operation 310 by obtaining, by one or more processors, a learning objective for a class session. Student interactions are monitored at operation 320 during the class session to collect student interaction data. Monitoring student interactions may be performed by periodically receiving representations of content displayed on a student computing device. A length of time that a site is being displayed on the student computing device may be calculated by comparing the received representations and adding up the periods between the received representations that are still associated with the site.

The collected student interaction data is analyzed using a machine learning model at operation 330. The model is trained to identify patterns indicative of engagement or disengagement with the learning objective, wherein the machine learning model applies a topic analysis algorithm to content accessed by the students to determine a relevance score relative to the predefined learning objective. An engagement status is then determined at operation 340 for each student based on the relevance score and a predetermined engagement threshold. Real-time feedback for an educator based on the engagement status or each student is generated at operation 350, wherein the feedback includes actionable recommendations for interventions to enhance engagement.

In one example, the machine learning model is trained using a supervised learning algorithm, and the training data comprises labeled examples of student interactions that have been annotated as ‘engaged’ or ‘disengaged’ based on their correlation with the predefined learning objective.

The supervised learning algorithm may include one or more of a Support Vector Machines (SVM), Decision Trees, Random Forests, Gradient Boosting Machines, or Neural Networks.

The topic analysis algorithm may utilize Natural Language Processing (NLP) techniques to extract features from text, including one or more of the following: named entity recognition, part-of-speech tagging, sentiment analysis, or topic modeling.

The topic modeling may be performed using Latent Dirichlet Allocation (LDA) or Non-negative Matrix Factorization (NMF) to identify topics within the educational content and compare them to the predefined learning objective.

The machine learning model may include an image recognition component that utilizes Convolutional Neural Networks (CNNs) to analyze visual content accessed by the students and determine its relevance to the predefined learning objective.

In one example, the machine learning model applies sequence analysis algorithms to assess patterns in student activity over time, including one or more of the following: Hidden Markov Models (HMMs), Recurrent Neural Networks (RNNs), or Long Short-Term Memory networks (LSTMs).

In a further example, the machine learning model utilizes anomaly detection techniques to identify deviations from typical engagement patterns, employing algorithms such as One-Class SVM or Isolation Forest.

The machine learning model may incorporate clustering techniques to group students based on similarity in engagement patterns, using algorithms such as K-means clustering or hierarchical clustering.

The machine learning model in one example is configured to update its parameters dynamically based on reinforcement learning, with the one or more processors providing feedback to the model based on an effectiveness of previous engagement status determinations and interventions.

FIG. 4 is a flowchart illustrating a method 400 of generating, by one or more processors, nudges for students who are found to be not on-track to interacting in a manner consistent with a learning objective. Method 400 begins at operation 410 by monitoring, by one or more processors, student interactions with computing devices during a class session to collect student interaction data.

Operation 420 obtains an engagement score representative of a student being on track by interacting with content relevant to a predefined learning objective. A communication is selected and sent to the student to direct the student to interactions to increase the engagement score at operation 430. The commutation may be selected and sent in response to engagement score being below a predetermined engagement score threshold. The engagement score threshold is settable by an instructor.

Operation 440 monitors student interactions following the communication to determine a post communication engagement score. A operation 450, an effectiveness score of the communication is modified based on a change between the post communication engagement score and the engagement score.

In one example, an instructor interface is provided to enable selection of the communication from a list of multiple different communications. A least one of the multiple communications comprises text describing the learning objective. In a further example, at least one of the multiple communications comprises a resource recommendation. Each of the multiple communications include an effectiveness score that is updated based on a change between the post communication engagement scores and the engagement scores in response to the communication being sent to multiple students.

In one example, the effectiveness score is decreased if the post communication engagement score minus the engagement score is less than an effectiveness engagement score threshold. The effectiveness score may be increased if the post communication engagement score minus the engagement score is less than an effectiveness engagement score threshold.

In one example, time since a beginning of the class is tracked, and the communication is sent to the student in response to the time meeting or exceeding a nudge time threshold. The nudge time threshold may be set by the instructor. The instructor may consider the type of learning objective. If the learning object involves research, the nudge time threshold may be higher than for a learning objective that is related to one or more specific topics. The nudge time threshold may be suggested by the system based on a comparison of nudge time thresholds for similar prior learning objectives.

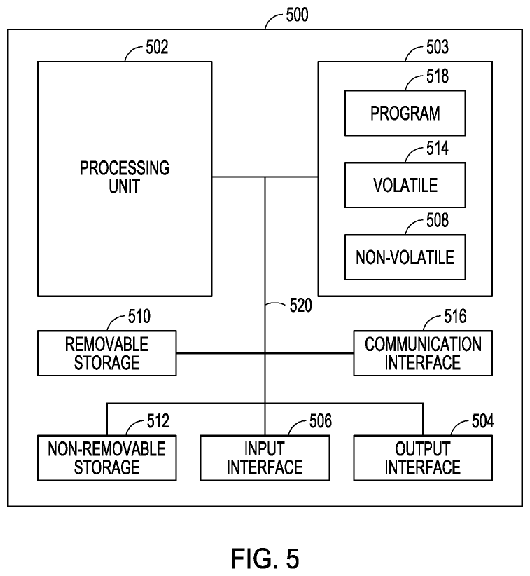

FIG. 5 is a block schematic diagram of a computer system 500 to implement one or more systems, user interfaces, and models for the education platform and for performing methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 503 may include volatile memory 514 and non-volatile memory 508. Computer 500 may include-or have access to a computing environment that includes-a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### EXAMPLES

1. A computer implemented method includes monitoring, by one or more processors, student interactions with computing devices during a class session to collect student interaction data and obtaining an engagement score representative of a student being on track by interacting with content relevant to a predefined learning objective. A communication is selected to direct the student to interactions to increase the engagement score. Following the communication, student interactions are monitored to determine a post communication engagement score. An effectiveness score of the communication is modified based on a change between the post communication engagement score and the engagement score.

2. The method of example 1 wherein the engagement score is below a predetermined engagement score threshold.

3. The method of example 2 wherein the engagement score threshold is settable by an instructor.

4. The method of any of examples 1-3 and further including providing an instructor interface to enable selection of the communication from a list of multiple different communications.

5. The method of example 4 wherein at least one of the multiple communications comprises text describing the learning objective.

6. The method of any of examples 4-5 wherein at least one of the multiple communications comprises a resource recommendation.

7. The method of any of examples 4-6 wherein each of the multiple communications include an effectiveness score that is updated based on a change between the post communication engagement scores and the engagement scores in response to the communication being sent to multiple students.

8. The method of example 7 wherein the effectiveness score is decreased if the post communication engagement score minus the engagement score is less than an effectiveness engagement score threshold.

9. The method of any of examples 4-8 wherein the effectiveness score is increased if the post communication engagement score minus the engagement score is less than an effectiveness engagement score threshold.

10. The method of any of examples 1-9 and further including tracking a time since a beginning of the class and wherein the communication is sent to the student in response to the time meeting or exceeding a nudge time threshold.

11. A machine-readable storage device has instructions for execution by a processor of a machine to cause the processor to perform operations to perform any of the methods of examples 1-10.

12. A device includes a processor and a memory device coupled to the processor and having a program stored thereon for execution by the processor to perform operations to perform any of the methods of examples 1-10.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
monitoring, by one or more processors, student interactions with student computing devices during a class session to collect student interaction data including content displayed on the student computing devices;
obtaining, at the one or more processors, an engagement score representative of a student being on track by interacting with content relevant to a predefined learning objective, wherein the engagement score is a function of a weighted relevance score derived by a machine learning language model comparing content displayed on the student computing device to the predefined learning objective to determine the relevance score of the content displayed on the student computing device to the predefined learning objective and a weighted time value of student interaction with the content displayed on the student computing device;
selecting, via the one or more processors, a communication, the communication selected to direct the student to interactions to increase the engagement score;
monitoring student interactions following the communication to determine a post communication engagement score via the machine learning language model; and
modifying an effectiveness score of the communication based on a change between the post communication engagement score and the engagement score.

2. The method of claim 1 wherein the engagement score is below a predetermined engagement score threshold.

3. The method of claim 2 wherein the engagement score threshold is settable by an instructor.

4. The method of claim 1 further comprising providing an instructor interface to enable selection of the communication from a list of multiple different communications.

5. The method of claim 4 wherein at least one of the multiple communications comprises text describing the learning objective.

6. The method of claim 4 wherein at least one of the multiple communications comprises a resource recommendation.

7. The method of claim 4 wherein each of the multiple communications include an effectiveness score that is updated based on a change between the post communication engagement scores and the engagement scores in response to the communication being sent to multiple students.

8. The method of claim 7 wherein the effectiveness score is decreased if the post communication engagement score minus the engagement score is less than an effectiveness engagement score threshold.

9. The method of claim 7 wherein the effectiveness score is increased if the post communication engagement score minus the engagement score is greater than an effectiveness engagement score threshold.

10. The method of claim 1 further comprising:
tracking a time since a beginning of the class; and
wherein the communication is sent to the student in response to the time meeting or exceeding a nudge time threshold.

11. A machine-readable storage device having instructions for execution by one or more processors of a machine to cause the one or more processors to perform operations to perform a method, the operations comprising:
monitoring, by one or more processors, student interactions with student computing devices during a class session to collect student interaction data including content displayed on the student computing devices;
obtaining, at the one or more processors, an engagement score representative of a student being on track by interacting with content relevant to a predefined learning objective, wherein the engagement score is a function of a weighted relevance score derived by a machine learning language model comparing content displayed on the student computing device to the predefined learning objective to determine the relevance score of the content displayed on the student computing device to the predefined learning objective and a weighted time value of student interaction with the content displayed on the student computing device;
selecting, via the one or more processors, a communication, the communication selected to direct the student to interactions to increase the engagement score;
monitoring student interactions following the communication to determine a post communication engagement score; and
modifying an effectiveness score of the communication based on a change between the post communication engagement score and the engagement score.

12. The device of claim 11 wherein the engagement score is below a predetermined engagement score threshold.

13. The device of claim 11 further comprising providing an instructor interface to enable selection of the communication from a list of multiple different communications.

14. The device of claim 13 wherein at least one of the multiple communications comprises text describing the learning objective.

15. The device of claim 13 wherein at least one of the multiple communications comprises a resource recommendation.

16. The device of claim 13 wherein each of the multiple communications include an effectiveness score that is updated based on a change between the post communication engagement scores and the engagement scores in response to the communication being sent to multiple students.

17. The device of claim 16 wherein the effectiveness score is decreased if the post communication engagement score minus the engagement score is less than an effectiveness engagement score threshold and the effectiveness score is increased if the post communication engagement score minus the engagement score is greater than the effectiveness engagement score threshold.

18. The device of claim 11 wherein the operations further comprise:
tracking a time since a beginning of the class; and
wherein the communication is sent to the student in response to the time meeting or exceeding a nudge time threshold.

19. A device comprising:
one or more processors; and
a memory device coupled to the one or more processors and having a program stored thereon for execution by the one or more processors to perform operations comprising:
monitoring, by one or more processors, student interactions with student computing devices during a class session to collect student interaction data including content displayed on the student computing devices;
obtaining, at the one or more processors, an engagement score representative of a student being on track by interacting with content relevant to a predefined learning objective, wherein the engagement score is a function of a weighted relevance score derived by a machine learning language model comparing content displayed on the student computing device to the predefined learning objective to determine the relevance score of the content displayed on the student computing device to the predefined learning objective and a weighted time value of student interaction with the content displayed on the student computing device;
selecting, via the one or more processors, a communication, the communication selected to direct the student to interactions to increase the engagement score;
monitoring student interactions following the communication to determine a post communication engagement score; and
modifying an effectiveness score of the communication based on a change between the post communication engagement score and the engagement score.

20. The device of claim 16 wherein the effectiveness score is decreased if the post communication engagement score minus the engagement score is less than an effectiveness engagement score threshold and the effectiveness score is increased if the post communication engagement score minus the engagement score is greater than the effectiveness engagement score threshold, and wherein the operations further comprise:
tracking a time since a beginning of the class; and
wherein the communication is sent to the student in response to the time meeting or exceeding a nudge time threshold.
